(19) United States
(12) Patent Application Publication
(10) Pub. No.: US 2004/0198243 A1
(43) Pub. Date: Oct. 7, 2004

(54) Mobile phone with a replaceable face panel

(76) Inventors: Tony Tasy, Taipei City (TW); James Chen, Taipei City (TW)

Correspondence Address: NIXON & VANDERHYE, P.C., 8th Floor, 1100 North Glebe Road, Arlington, VA, 22201-4714, US

(21) Appl. No.: 10/216,827

(22) Filed: Aug. 13, 2002

(51) Int. Cl. H04B 1/38; H04M 1/00

(52) U.S. Cl. 455/90.1; 455/550.1

(57) ABSTRACT

A mobile phone includes a mobile phone body, a face panel, an interlocking unit and a stop mechanism. The stop mechanism is provided on at least one of the face panel and the mobile phone body and functions so as to arrest movement of the face panel relative to the mobile phone body.

### BACKGROUND OF THE INVENTION

1. Field of the Invention

This invention relates to a mobile phone, more particularly to a mobile phone with a replaceable face panel.

2. Description of the Related Art

Commercially available mobile phones are so designed that the face panel thereof are replaceable. Commonly, a hook-and-groove assembly is used as a fastening mechanism for the face panel. However, because of the poor durability of the hook-and-groove assembly, falling apart of the face panel is likely to occur in the event of frequent replacement of the face panel.

### SUMMARY OF THE INVENTION

Therefore, the object of the present invention is to provide a mobile phone that is free of the aforesaid drawback that is associated with the prior art.

According to this invention, a mobile phone includes a mobile phone body, a face panel, an interlocking unit, and a stop mechanism.

The mobile phone body has a top surface and a bottom surface opposite to the top surface in a vertical direction. The face panel has a bottom side to be superimposed removably on the top surface of the mobile phone body so as to cover the top surface of the mobile phone body. The interlocking unit includes a set of engaging hooks provided on one of the top surface of the mobile phone body and the bottom side of the face panel, and a set of engaging grooves provided on the other of the top surface of the mobile phone body and the bottom side of the face panel. Each of the engaging grooves is configured with an access portion and a restraining portion that extends from the access portion in a first direction transverse to the vertical direction. The access portion permits unrestrained movement of a respective one of the engaging hooks in the vertical direction into and out of the engaging groove such that the face panel is removably disposed on the mobile phone body. The face panel is movable relative to the mobile phone body in the first direction to move each of the engaging hooks from the access portion to the restraining portion of the respective one of the engaging grooves. The restraining portion prevents movement of the respective one of the engaging hooks in the vertical direction to fasten the face panel on the mobile phone body. The stop mechanism is provided on at least one of the face panel and the mobile phone body, and functions so as to arrest movement of the face panel in a second direction opposite to the first direction relative to the mobile phone body.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded perspective view of the preferred embodiment of the mobile phone with replaceable face panel according to the present invention;

FIG. 2 is a partly exploded bottom perspective view to illustrate a stop mechanism of the preferred embodiment;

FIG. 3 is a bottom perspective view illustrating a blocking member of the stop mechanism in an unblocking position;

FIG. 4 is a schematic bottom view illustrating the bottom surface of the mobile phone body of the preferred embodiment according to the present invention when a back cover is removed;

FIG. 5 is a schematic partly cross-sectional view taken along lines V-V of FIG. 4;

FIG. 6 is a view similar to FIG. 4 but illustrating the blocking member in a blocking position; and

FIG. 7 is a schematic partly view taken along lines VII-VII of FIG. 6.

### DETAILED DESCRIPTION OF THE PREFERRED EMBODIMENT

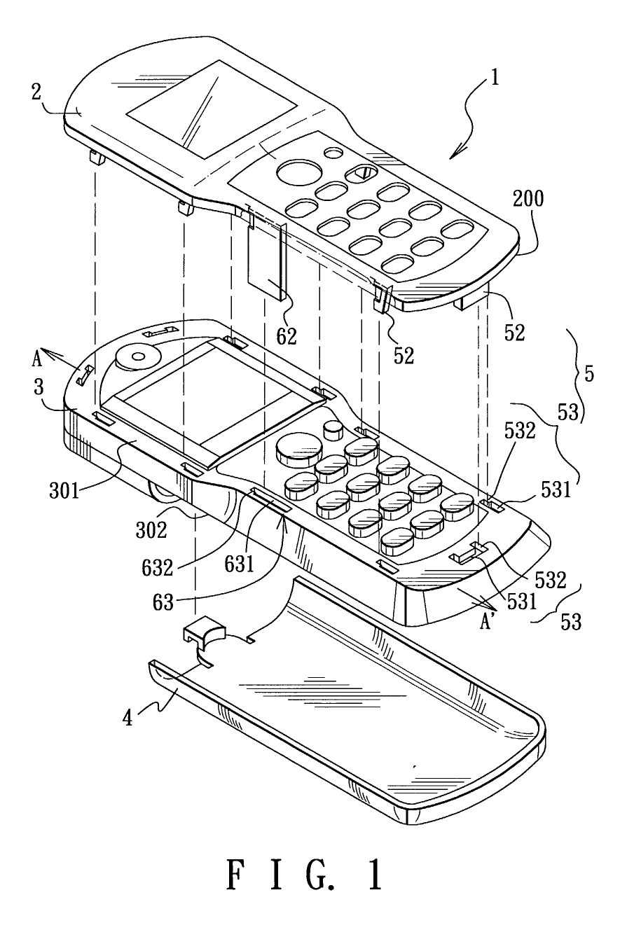

Referring to FIGS. 1, 2 and 3, the preferred embodiment of the mobile phone 1 according to the present invention is shown to include a mobile phone body 3, a face panel 2, an interlocking unit 5 and a stop mechanism 6.

The mobile phone body 3 has a top surface 301 and a bottom surface 302 opposite to the top surface 301 in a vertical direction. The face panel 2 has a bottom side 200 to be superimposed removably on the top surface 301 of the mobile phone body 3 so as to cover the top surface 301 of the mobile phone body 3.

The interlocking unit 5 includes a set of engaging hooks 52 provided on the bottom side 200 of the face panel 2, and a set of engaging grooves 53 provided on the top surface 301 of the mobile phone body 3. Each of the engaging grooves 53 is configured with an access portion 531 and a restraining portion 532 that extends from the access portion 531 in a first direction (A) transverse to the vertical direction. The access portion 532 permits unrestrained movement of a respective one of the engaging hooks 52 in the vertical direction into and out of the engaging groove 53 such that the face panel 2 is removably disposed on the mobile phone body 3. The face panel 2 is movable relative to the mobile phone body 3 in the first direction (A) to move each of the engaging hooks 52 from the access portion 531 to the restraining portion 532 of the respective one of the engaging grooves 53. The restraining portion 532 prevents movement of the respective one of the engaging hooks 52 in the vertical direction to fasten the face panel 2 on the mobile phone body 3.

In this embodiment, the stop mechanism 6 is provided on the face panel 2 and the mobile phone body 3 and functions so as to arrest movement of the face panel 2 in a second direction (A′) opposite to the first direction (A) relative to the mobile phone body 3.

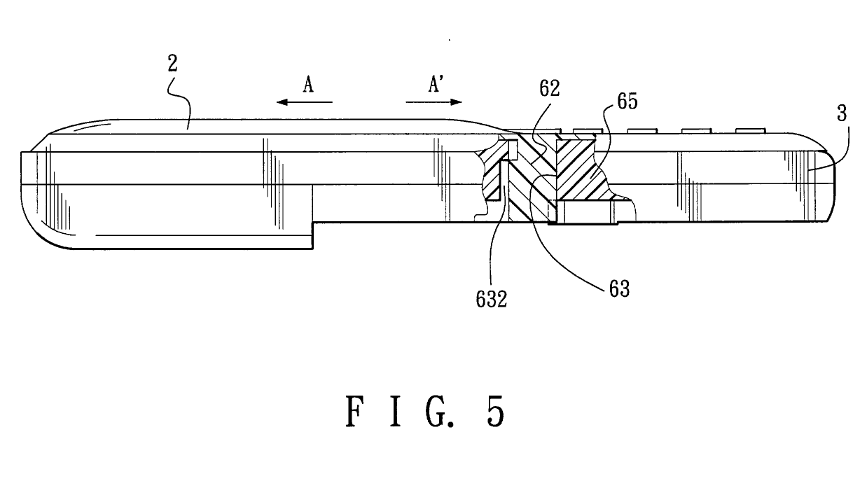

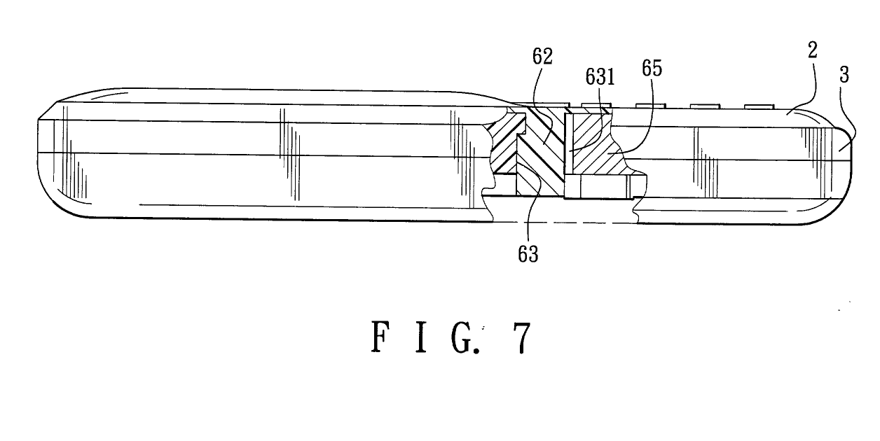

Preferably, the mobile phone body 3 is formed with a guide slot 63 that extends in the vertical direction from the top surface 301 through the bottom surface 302, as best shown in FIGS. 5 and 7. The guide slot 63 has a first slot portion 631 and a second slot portion 632 opposite to the first slot portion 631 in the first direction (A). The stop mechanism 6 includes a limiting arm 62 and a blocking member 65. The limiting arm 62 extends downwardly from the bottom side 200 of the face panel 2 and through the guide slot 63. The limiting arm 62 is movable in the guide slot 63 so as to be disposed in the first slot portion 631 of the guide slot 63 (see FIG. 5) when the engaging hooks 52 are disposed in the access portions 531 of the engaging grooves 53, and so as to be disposed in the second slot portion 632 of the guide slot 63 (see FIG. 7) when the engaging hooks 52 are disposed in the restraining portions 532 of the engaging grooves 53.

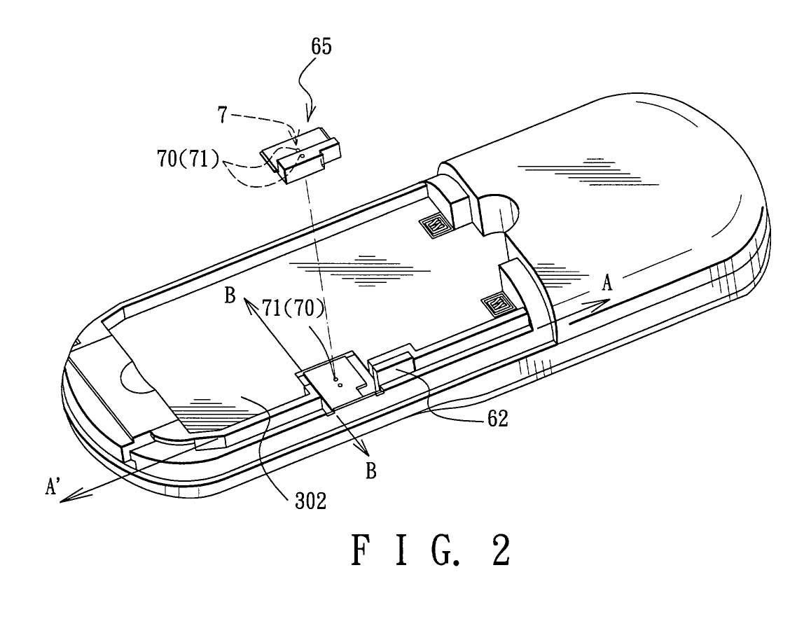

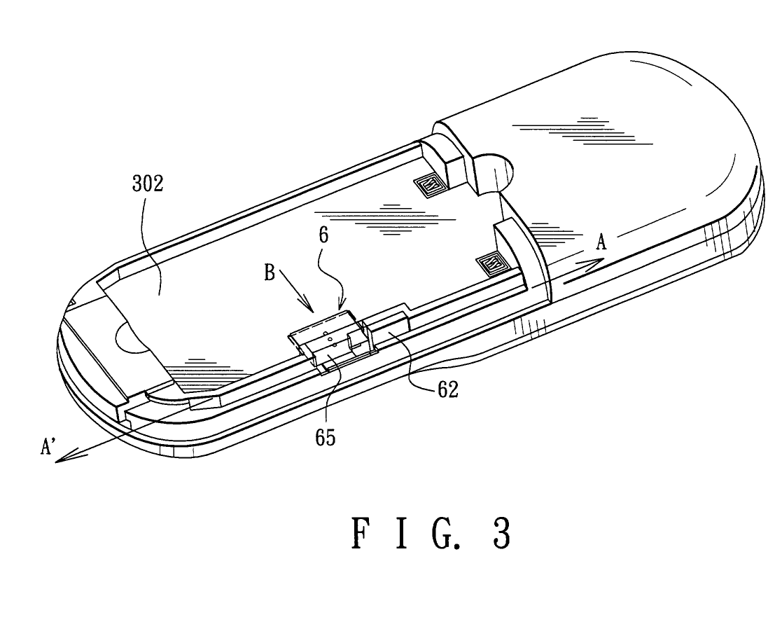

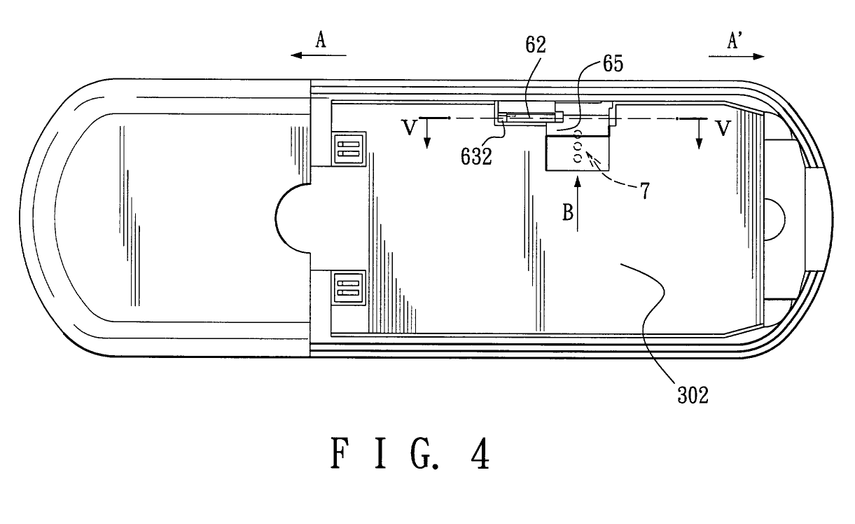

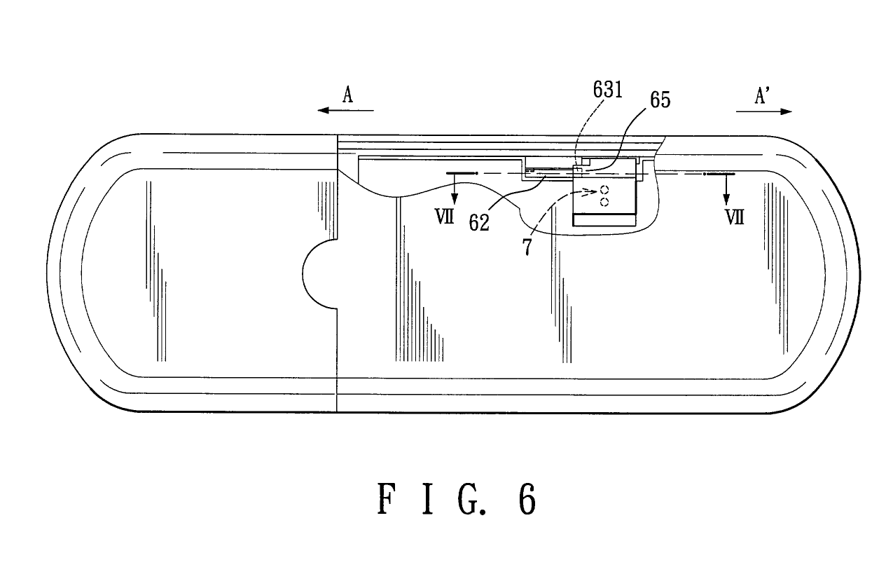

Referring once again to FIGS. 2 and 3, in this embodiment, the blocking member 65 is mounted movably on the bottom surface 302 of the mobile phone body 3 and is movable from a blocking position, where the blocking member 65 abuts against and prevents movement of the limiting arm 62 in the second direction (A′) from the second slot portion 632 to the first slot portion 631 (see FIGS. 4 and 5), and an unblocking position, where the blocking member 65 is disengaged from and permits movement of the limiting arm 62 between the first and second slot portions 631, 632 (see FIGS. 6 and 7). Preferably, the blocking member 65 is mounted slidably on the bottom surface 302 of the mobile phone body 3 and is slidable in a transverse direction (B) transverse to the vertical, first and second directions (A), (A′).

In this embodiment, the stop mechanism 6 further includes a positioning unit 7 provided on the blocking member 65 and the bottom surface 302 of the mobile phone body 3 for retaining releasably the blocking member 65 in a selected one of the blocking and unblocking positions. In this preferred embodiment, the positioning unit 7 includes at least one rounded protrusion 71 provided on one of the blocking member 65 and the bottom surface 302 of the mobile phone body 3, and at least one concave recess 70 provided on the other of the blocking member 65 and the bottom surface 302 of the mobile phone body 3 to engage removably the rounded protrusion 71 (see FIGS. 2, 4 and 6).

In this embodiment, the mobile phone 1 further comprises a back cover 4 (see FIG. 1) mounted removably on the bottom surface 302 of the mobile phone body 3 to conceal the stop mechanism 6. Furthermore, the back cover 4 may be integrated with a battery unit (not shown) for power supply purposes.

By virtue of the interlocking unit 5 and the stop mechanism 6, frequent replacement of the face panel 2 can be conducted without damaging the interlocking unit 5. The object of the invention is thus met.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

We claim:

1. A mobile phone comprising:
a mobile phone body having a top surface and a bottom surface opposite to said top surface in a vertical direction;
a face panel having a bottom side to be superimposed removably on said top surface of said mobile phone body so as to cover said top surface of said mobile phone body;
an interlocking unit including a set of engaging hooks provided on one of said top surface of said mobile phone body and said bottom side of said face panel, and a set of engaging grooves provided on the other of said top surface of said mobile phone body and said bottom side of said face panel, each of said engaging grooves being configured with an access portion and a restraining portion that extends from said access portion in a first direction transverse to the vertical direction, said access portion permitting unrestrained movement of a respective one of said engaging hooks in the vertical direction into and out of said engaging groove such that said face panel is removably disposed on said mobile phone body, said face panel being movable relative to said mobile phone body in the first direction to move each of said engaging hooks from said access portion to said restraining portion of the respective one of said engaging grooves, said restraining portion preventing movement of the respective one of said engaging hooks in the vertical direction to fasten said face panel on said mobile phone body; and
a stop mechanism provided on at least one of said face panel and said mobile phone body and functioning so as to arrest movement of said face panel in a second direction opposite to the first direction relative to said mobile phone body.

2. The mobile phone as claimed in claim 1, wherein said mobile phone body is formed with a guide slot that extends in the vertical direction from said top surface through said bottom surface, said guide slot having a first slot portion and a second slot portion opposite to said first slot portion in the first direction, said stop mechanism including:
a limiting arm extending downwardly from said bottom side of said face panel and through said guide slot, said limiting arm being movable in said guide slot so as to be disposed in said first slot portion of said guide slot when said engaging hooks are disposed in said access portions of said engaging grooves, and so as to be disposed in said second slot portion of said guide slot when said engaging hooks are disposed in said restraining portions of said engaging grooves; and
a blocking member mounted movably on said bottom surface of said mobile phone body and movable from a blocking position, where said blocking member abuts against and prevents movement of said limiting arm in the second direction from said second slot portion to said first slot portion, and an unblocking position, where said blocking member is disengaged from and permits movement of said limiting arm between said first and second slot portions.

3. The mobile phone as claimed in claim 2, wherein said blocking member is mounted slidably on said bottom surface of said mobile phone body and is slidable in a transverse direction transverse to the vertical, first and second directions.

4. The mobile phone as claimed in claim 3, wherein said stop mechanism further includes a positioning unit provided on said blocking member and said bottom surface of said mobile phone body for retaining releasably said blocking member in a selected one of the blocking and unblocking positions.

5. The mobile phone as claimed in claim 4, wherein said positioning unit includes at least one rounded protrusion provided on one of said blocking member and said bottom surface of said mobile phone body, and at least one concave recess provided on the other of said blocking member and said bottom surface of said mobile phone body to engage removably said rounded protrusion.

6. The mobile phone as claimed in claim 2, further comprising a back cover mounted removably on said bottom surface of said mobile phone body to conceal said stop mechanism.
